(19) United States
(12) Patent Application Publication
(10) Pub. No.: US 2013/0320798 A1
(43) Pub. Date: Dec. 5, 2013

(54) SYSTEM AND METHOD FOR REDUCING COGGING TORQUE IN AN INTERIOR PERMANENT MAGNET MOTOR

(71) Applicants: Mohammad S. Islam, Saginaw, MI (US); Scott T. Blehm, Saginaw, MI (US); Mazharul H. Chowdhury, Midland, MI (US)

(72) Inventors: Mohammad S. Islam, Saginaw, MI (US); Scott T. Blehm, Saginaw, MI (US); Mazharul H. Chowdhury, Midland, MI (US)

(73) Assignee: STEERING SOLUTIONS IP HOLDING CORPORATION, Saginaw, MI (US)

(21) Appl. No.: 13/483,514

(22) Filed: May 30, 2012

(51) Int. Cl. H02K 1/27

(52) U.S. Cl. 310/156.53

(57) ABSTRACT

An interior permanent magnet motor comprises a rotor assembly disposed within a stator assembly. The rotor assembly is configured for rotating about a central axis relatively to the stator assembly. The rotor assembly defines a plurality of magnet pockets within the rotor assembly along a radially outboard surface of the rotor assembly. Each magnet pocket is substantially rectangular in cross-sectional shape and is configured to facilitate insertion of a permanent magnet into, and retention of the permanent magnet within, the magnet pocket. The rotor assembly further defines at least one rotor notch disposed between each magnet pocket and the radially outboard surface.

### BACKGROUND OF THE INVENTION

The subject invention relates to system and method for reducing cogging torque in an interior permanent magnet (IPM) motor.

Brushless DC (BLDC) motors, such as permanent magnet (PMBLDC or PMSM) motors, provide a number of advantages over brushed motors, including increased torque density, increased reliability and durability, and reduction of electromagnetic interference (EMI). Therefore, BLDC motors are commonly used for high performance industrial applications such as in electrically assisted power steering systems in vehicles. Electrically assisted power steering systems are quickly becoming a desirable alternative to the hydraulically assisted power steering systems. In such systems, an electric motor is connected to the steering rack via a gear mechanism. Sensors may be used to measure various parameters such as hand wheel torque and position, and a control system may use signals from the sensors, along with other vehicle operating parameters to facilitate control over the electric motor drive and to thereby lend desirable steering characteristics to the vehicle.

While use of electrical motors in systems such as electrical power steering assist systems offers many advantages, configuring a BLDC motor to produce an acceptable set of output characteristics is not without challenges. A BLDC motor includes a plurality of permanent magnets fixed to a moving assembly (i.e., a rotor assembly), which rotates within, and relatively to, a fixed armature (i.e., a stator assembly). Outboard of the rotor assembly, the stator assembly hosts the motor windings such that they may be cooled by conduction rather than convection, facilitating the complete enclosure of the motor assembly for improved protection from infiltration of water, dirt, and/or other foreign matter. An Interior Permanent Magnet (IPM) motor comprises a plurality of magnet blocks that are embedded internally within the rotor core to provide for improved magnet retention relative to motors wherein magnets are mounted to the external surfaces of the rotor core.

Unfortunately, as the permanent magnets mounted in or on the rotor interact with the static structure (e.g., the slots) of the stator, various periodically varying phenomena, such as torque ripple, vibrations and speed pulsations, may be experienced. These unfavorable characteristics are generally related to the magnitude, and variations in magnitude, of cogging torque, which is also known as detent or ‘no-current’ torque. Because cogging torque is caused by interaction between the magnets of the rotor and the static structure, cogging torque varies with changes in rotor position. Cogging torque may be very noticeable at low rotor speeds, causing jerkiness in motor output. Accordingly, it is desirable to reduce cogging torque and increase motor output torque in a BLDC motor.

Various techniques have been used in attempts to reduce cogging torque and increase motor output torque. These include magnet pole shaping, linear skew of rotor magnets or stator, step-skew of the magnets, slot/pole combination, magnet shaping, and incorporation of dummy notches in stator teeth. Unfortunately, though, efforts to reduce cogging torque and increase motor output torque in IPM motors have achieved only limited success because IPM motors typically include relatively small air gaps and relatively simple rectangular magnet shapes. As a result, the potential for reducing cogging torque in IPM motors may be limited.

Accordingly, it is desirable to have an improved system and method for reducing cogging torque in IPM motors.

### SUMMARY OF THE INVENTION

In one exemplary embodiment of the invention, an interior permanent magnet motor comprises a rotor assembly disposed within a stator assembly. The rotor assembly is configured for rotating about a central axis relatively to the stator assembly. The rotor assembly defines a plurality of magnet pockets within the rotor assembly along a radially outboard surface of the rotor assembly. Each magnet pocket is substantially rectangular in cross-sectional shape and is configured to facilitate insertion of a permanent magnet into, and retention of the permanent magnet within, the magnet pocket. The rotor assembly further defines at least one rotor notch disposed between each magnet pocket and the radially outboard surface.

In another exemplary embodiment of the invention, a method for reducing cogging torque in an interior permanent magnet motor comprises providing a rotor assembly disposed within a stator assembly, the rotor assembly being configured for rotating about a central axis relatively to the stator assembly. A plurality of magnet pockets is defined within the rotor assembly along a radially outboard surface of the rotor assembly. Each magnet pocket is substantially rectangular in cross-sectional shape, and each magnet pocket is configured to facilitate insertion of a permanent magnet into, and retention of the permanent magnet within, the magnet pocket. At least one rotor notch is further defined within the rotor assembly, disposed between each magnet pocket and the radially outboard surface.

The above features and advantages and other features and advantages of the invention are readily apparent from the following detailed description of the invention when taken in connection with the accompanying drawings.

### BRIEF DESCRIPTION OF THE DRAWINGS

The subject matter which is regarded as the invention is particularly pointed out and distinctly claimed in the claims at the conclusion of the specification. The foregoing and advantages and details appear, by way of example only, in the following detailed description of embodiments taken in conjunction with the accompanying drawings in which:

FIG. 1 is a drawing showing a cross section of an exemplary embodiment of an IPM motor;

FIG. 2 is a drawing showing a cross section of a portion of an exemplary embodiment of an IPM motor;

FIG. 3 is a drawing showing a cross section of a portion of an exemplary embodiment of an IPM motor; and

FIG. 4 illustrates an exemplary method for reducing cogging torque in an interior permanent magnet motor.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

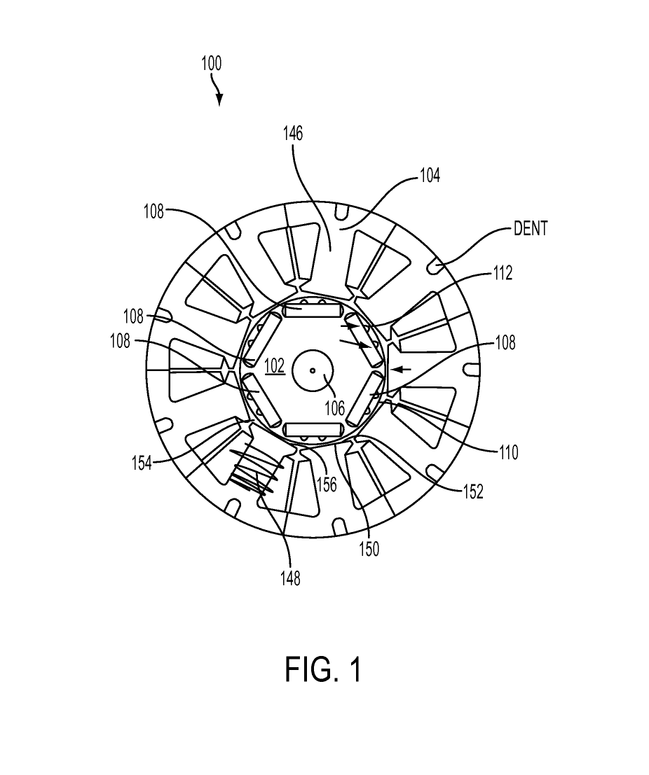

Referring now to the Figures, in which the invention will be described with reference to specific embodiments, without limiting same, FIG. 1 shows a cross section of an exemplary embodiment of an IPM motor 100 comprising a rotor assembly 102 that is disposed for rotation within, and relatively to, a stator assembly 104. The rotor assembly 102 is configured to rotate about a central axis 106 and defines a plurality of magnet pockets 108 distributed within the rotor assembly 102 along a radially outboard surface 110 of the rotor assembly 102. Associated with each magnet pocket 108 is one or more rotor notches 112 disposed between the magnet pocket 108 and the radially outboard surface 110.

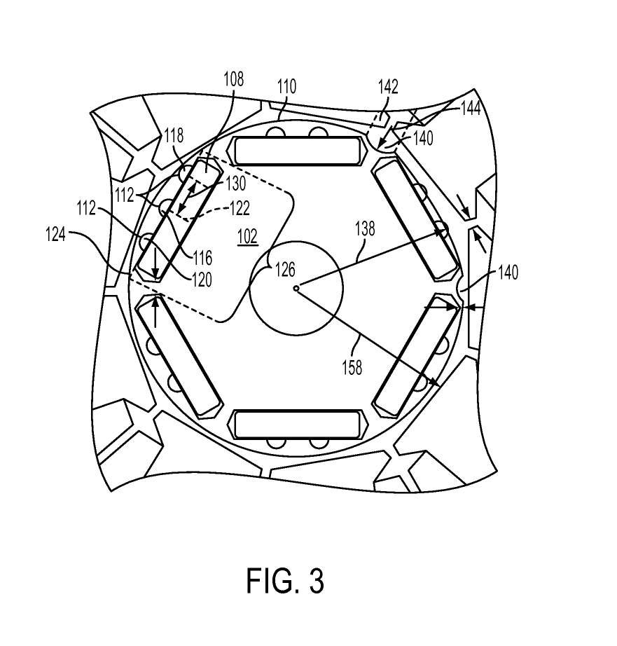

As shown in FIG. 1, in an exemplary embodiment, each magnet pocket 108 is substantially rectangular in cross-sectional shape having a magnet pocket length along a chord 124 (see, e.g., FIG. 3) of the rotor assembly 102. In the embodiment shown in FIG. 1, a cross-section of each rotor notch 112 is configured as a portion of a circle. It should be appreciated, however, that other shapes are possible for each of the rotor notches 112, including V-shapes, triangular shapes, rectangular shapes, oval shapes, and other geometric shapes. Each magnet pocket 108 is configured to facilitate insertion of a permanent magnet (not shown) into the magnet pocket 108 while also providing acceptable retention and reliable positioning of the magnet within the magnet pocket 108.

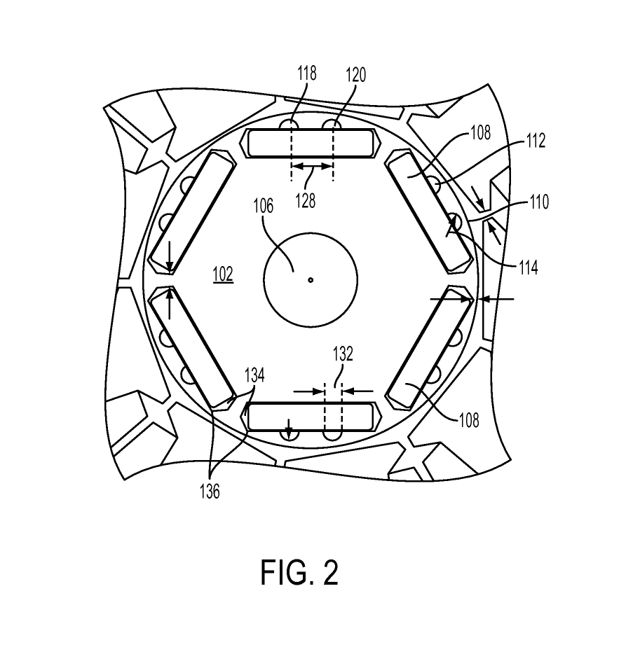

As shown in FIG. 2, each of the partially-circular rotor notches 112 has a characteristic notch radius 114. In an exemplary embodiment, the number of rotor notches 112 associated each of the magnet pockets 108 is configured so as to reduce cogging torque and increase motor output torque in the IPM brushless motor 100. Similarly, the size and shape of the rotor notches 112 (e.g., in a partially-circular rotor notch 112, the notch radius 114) may be configured so as to reduce cogging torque and increase motor output torque in the IPM brushless motor 100. As shown in FIG. 2, in an exemplary embodiment, two rotor notches 112 are associated each of the magnet pockets 108, and the notch radius 114 of each of those rotor notches is between about three percent and eight percent of the rotor assembly radius 138, and may be, for example, approximately equal to about 5.5 percent of the rotor assembly radius 138.

In an exemplary embodiment, as shown in FIG. 3, a rotor assembly 102 defines three rotor notches 112 adjacent to each of the magnet pockets 108, wherein the notch radius 114 of each of those rotor notches is between about two percent and seven percent of the rotor assembly radius 138, and may be, for example, approximately equal to about 4.5 percent of the rotor assembly radius 138. In accordance with this embodiment, a center notch 116 of the set of three notches 112 is positioned approximately adjacent to a center 122 of each magnet pocket 108 along a chord 124 that traverses a segment 126 of the outboard surface 110 of the rotor assembly 102. The center notch 116 is positioned between a pair of end notches 118, 120. Put another way, end notches 118, 120 are disposed about the center notch 116, along the magnet pocket 108, between the magnet pocket 108 and the radially outboard surface 110 of the rotor assembly 102. In an exemplary embodiment, end notches 118, 120 are disposed symmetrically about the center notch 116.

In embodiments having at least three rotor notches 112, the center notch 116 and end notches 118, 120 are positioned within the rotor assembly 102 so as to define a notch half distance 130 between each of the end notches 118, 120 and the center notch 116. In an exemplary embodiment, the notch half distance 130 is configured so as to reduce cogging torque and increase motor output torque in the IPM brushless motor 100. For example, in an exemplary embodiment, the notch half distance 130 may be between about twenty percent and thirty percent of a length of the magnet pocket 108, and may be, for example, approximately equal to about twenty-five percent of the length of the magnet pocket 108.

It should be noted that in embodiments having two rotor notches 112, end notches 118, 120 are positioned within the rotor assembly 102 so as to define a notch pair distance 128 between the end notches 118 and 120. In an exemplary embodiment, the notch pair distance 128 is configured so as to reduce cogging torque and increase motor output torque in the IPM brushless motor 100. For example, in an exemplary embodiment, the notch pair distance 128 may be between about twenty-five percent and forty percent of a length of the magnet pocket 108, and may be, for example, approximately equal to about one-third of the length of the magnet pocket 108.

In addition to having a notch radius 114, each notch 112 may also be characterized by a notch opening width 132, which may also be configured so as to reduce cogging torque and increase motor output torque. For example, a notch opening width 132 may be approximately equal to two times the notch opening radius 114. Alternatively, the notch opening width 132 may be greater than or less than two times the notch opening radius 114.

In an exemplary embodiment, the rotor assembly 102 may also define a number of other features associated with each of the magnet pockets 108, these features being configurable so as to reduce cogging torque and increase motor output torque. For example, the rotor assembly may define one or more end voids 134, each being positioned adjacent to a respective outboard corner 136 of each of the magnet pockets 108. Each end void 134 may be shaped as a void having a triangular cross section and may be disposed at an end of a magnet pocket 108 with a corner of the end void 134 being positioned substantially at the respective outboard corner 136. In an exemplary embodiment, the triangular cross section of the end void 134 is a substantially right triangle. In an alternative embodiment, the cross-sectional shape of the end void may be defined by an end of the magnet pocket 108 together with a continuous outline such as an arc or other curvilinear shape. As with other features described herein, the shape, orientation, size and position of each end void may be configured so as to reduce cogging torque and increase motor output torque.

In an exemplary embodiment, the outer surface 110 of the rotor assembly 102 defines a substantially cylindrical shape defining a rotor assembly radius 138 with at least one rotor dimple 140 positioned between each pair of adjacent outboard corners 136. The dimple width 142 and dimple radius 144 of each rotor dimple 140 may be configured so as to reduce cogging torque and increase motor output torque. In an exemplary embodiment, in addition to the rotor dimples 140, the outer surface 110 of the rotor assembly 102 is shaped so as to define a combination of straight lines and arcs. The shaping of the outer surface 110 of the rotor assembly 102 may provide for a minimum distance between each magnet pocket 108 and the outer surface 110. In an exemplary embodiment, a cross section of the outer surface 110 may comprise a number of substantially straight lines separated by rotor dimples and at least one arc. In an exemplary embodiment, the arc is disposed about an arc center that is separated a finite distance from the central axis 106.

The stator assembly 104 includes a plurality of winding posts 146, each supporting a wire coil 148. At the radially inward end 150 of each winding post 146 is a stator tooth 152. Each pair of adjacent stator teeth 152 is separated by a slot opening 154. A slot opening width 154 is chosen to be quite small for segmented and chained cores to aid in reducing cogging torque. In combination, the stator teeth 152 define an inner surface 156 of the stator assembly 104 having an inner surface radius 158. In an exemplary embodiment, the inner surface 156 is generally substantially cylindrical in shape (i.e., its inner surface radius 158 is substantially constant) and is oriented substantially symmetrically about the central axis 106. In an exemplary embodiment, the inner surface 156 of the stator assembly 104 is circular in cross-section, but its inner surface radius 158 varies with position along a direction parallel to the central axis 106. For example, the inner surface 156 may have a concave shape with respect to the central axis 106 such that the inner surface radius 158 is greater at a central distance along a direction parallel to the central axis 106. Alternatively, the inner surface 156 may have a convex shape with respect to the central axis 106 such that the inner surface radius 158 is lesser at a central distance along a direction parallel to the central axis 106.

In an exemplary embodiment, the shape of the inner surface 156 is configured to accommodate various manufacturing and operational difficulties including rotor-stator eccentricity, variation in magnets, variations in the positioning of magnets into pockets, transient effects, and varying loads imposed on the rotor assembly 102 and the stator assembly 104.

In an exemplary embodiment, a plurality of dents may be disposed on the outer surface 110 of the rotor assembly 102 in order to retain the segments or chained stacks that are laminated together so as to form the rotor assembly. The dents are configured so as to reduce cogging torque that may otherwise be attributable to the existence of interface zones between adjacent segments forming the rotor assembly 102.

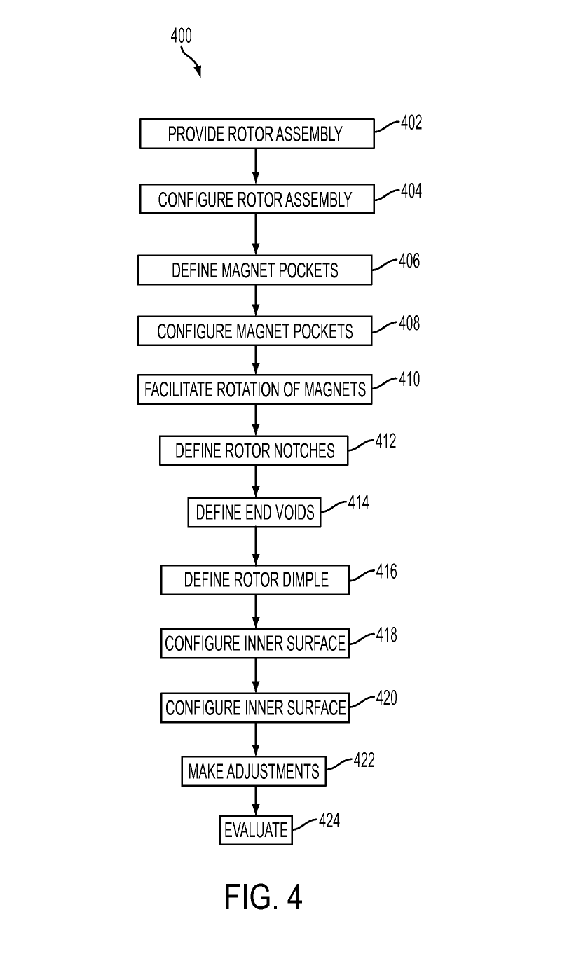

As shown in FIG. 4, an exemplary method 400 for reducing cogging torque in an interior permanent magnet motor includes providing a rotor assembly disposed within a stator assembly (step 402). The rotor assembly is configured for rotating about a central axis relatively to the stator assembly (step 404). A plurality of magnet pockets is defined within the rotor assembly along a radially outboard surface of the rotor assembly (step 406). Each magnet pocket is configured so as to have a substantially rectangular cross-sectional shape (step 408). Each magnet pocket is configured to facilitate insertion of a permanent magnet into, and retention of the permanent magnet within, the magnet pocket (step 410).

In an exemplary embodiment, at each magnet pocket, at least one rotor notch is defined within the rotor assembly so as to be disposed between the magnet pocket and the radially outboard surface (step 412). In an exemplary embodiment, at each magnet pocket, one or more end voids are defined within the rotor assembly such that each of the end voids is positioned adjacent to a respective outboard corner of the respective magnet pocket (step 414). In an exemplary embodiment, at least one rotor dimple is defined on the radially outboard surface of the rotor assembly so as top be positioned between two of the magnet pockets (step 416). In an exemplary embodiment, an inner surface of the stator assembly is configured so as to have a convex shape relative to the central axis (step 418). In an exemplary embodiment, an inner surface of the stator assembly is configured so as to have a concave shape relative to the central axis (step 420). Adjustments may be made to any or all of the positions, dimensions, quantity, and/or shapes of the above-described features (e.g., the magnet pockets, rotor notches, end voids, rotor dimples, and inner surface shape) so as to achieve desirable adjustments to cogging torque and/or torque output (step 422). Cogging torque and/or output torque may be evaluated with respect to a set of features so as to facilitate achievement of goals for cogging torque and/or output torque (step 424).

In accordance with exemplary embodiments of the invention, adjustments to cogging torque and/or output torque may be achieved. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as being limited by the foregoing description.

Having thus described the invention, it is claimed:

1. An interior permanent magnet motor comprising:
a rotor assembly disposed within a stator assembly;
the rotor assembly being configured for rotating about a central axis relatively to the stator assembly;
the rotor assembly defining a plurality of magnet pockets within the rotor assembly along a radially outboard surface of the rotor assembly, each magnet pocket being substantially rectangular in cross-sectional shape, and each magnet pocket being configured to facilitate insertion of a permanent magnet into and retention of the permanent magnet within, the magnet pocket;
the rotor assembly further defining at least one rotor notch disposed between each magnet pocket and the radially outboard surface.

2. The interior permanent magnet motor of claim 1, wherein a cross-section of each rotor notch is configured as a portion of a circle.

3. The interior permanent magnet motor of claim 1, the rotor assembly defining a set of at least two rotor notches disposed between each magnet pocket and the radially outboard surface.

4. The interior permanent magnet motor of claim 1, the rotor assembly defining a set of at least three rotor notches disposed between each magnet pocket and the radially outboard surface.

5. The interior permanent magnet motor of claim 4, wherein each set of at least three notches comprises a center notch that is positioned approximately adjacent to a center of a magnet pocket.

6. The interior permanent magnet motor of claim 4, wherein each set of at least three notches comprises a pair of end notches that are disposed symmetrically about the center notch.

7. The interior permanent magnet motor of claim 2, wherein each notch has an opening that is in communication with a respective magnet pocket, and wherein a width of each said opening is less than two times a radius of said circle.

8. The interior permanent magnet motor of claim 1, wherein the rotor assembly further defines one or more end voids associated with each said magnet pocket, each of said end voids being positioned adjacent to a respective outboard corner of said magnet pockets.

9. The interior permanent magnet motor of claim 7, wherein each end void is shaped as a void having a triangular cross section.

10. The interior permanent magnet motor of claim 8, wherein the cross section of each end void is defined by an end of the magnet pocket together with a continuous outline.

11. The interior permanent magnet motor of claim 1, wherein the outer surface of the rotor assembly defines a substantially cylindrical shape.

12. The interior permanent magnet motor of claim 10, wherein the outer surface includes at least one rotor dimple positioned between two of said magnet pockets.

13. The interior permanent magnet motor of claim 1, wherein the stator assembly defines an inner surface of the stator assembly that has circular cross-section at a position along the central axis, the circular cross section defining an inner surface radius with respect to the central axis.

14. The interior permanent magnet motor of claim 12, wherein the inner surface radius varies with position along the central axis.

15. The interior permanent magnet motor of claim 13, wherein the inner surface has a concave shape with respect to the central axis such that the inner surface radius is greatest at an interior location along the central axis.

16. The interior permanent magnet motor of claim 13, wherein the inner surface has a convex shape with respect to the central axis such that the inner surface radius is greatest at an exterior location along the central axis.

17. A method for reducing cogging torque in an interior permanent magnet motor comprising:
providing a rotor assembly disposed within a stator assembly, the rotor assembly being configured for rotating about a central axis relatively to the stator assembly;
defining a plurality of magnet pockets within the rotor assembly along a radially outboard surface of the rotor assembly, each magnet pocket being substantially rectangular in cross-sectional shape, and each magnet pocket being configured to facilitate insertion of a permanent magnet into and retention of the permanent magnet within, the magnet pocket; and
further defining, within the rotor assembly, at least one rotor notch disposed between each magnet pocket and the radially outboard surface.

18. The method of claim 17, further comprising defining, within the rotor assembly, one or more end voids associated with each said magnet pocket, each of said end voids being positioned adjacent to a respective outboard corner of said magnet pockets.

19. The method of claim 17, further comprising defining, on the radially outboard surface of the rotor assembly, at least one rotor dimple positioned between two of said magnet pockets.

20. The method of claim 17, further comprising defining, on an inner surface of the stator assembly, a convex shape relative to the central axis.
